(19) United States
(12) Patent Application Publication
(10) Pub. No.: US 2008/0103826 A1
(43) Pub. Date: May 1, 2008

(54) Health Care Payment Single Payor Facilitation System And Method

(75) Inventor: J. Christopher Barrett, San Diego, CA (US)

Correspondence Address: BAKER & DANIELS LLP, 300 NORTH MERIDIAN STREET, SUITE 2700, INDIANAPOLIS, IN, 46204, US

(73) Assignee: Centric Health Finance, La Jolla, CA (US)

(21) Appl. No.: 11/929,545

(22) Filed: Oct. 30, 2007

Related U.S. Application Data
(60) Provisional application No. 60/863,700, filed on Oct. 31, 2006.

(51) Int. Cl. G06Q 20/00; G06F 17/30; G06Q 50/00; G06F 17/40

(52) U.S. Cl. 705/2

(57) ABSTRACT

The invention relates to the field of health care reimbursement, and more particularly to valuing claims generated by a health care provider for purposes of underwriting and accelerating such health care provider's reimbursement from a variety of payors.

### BACKGROUND OF THE INVENTION

1. Field of the Invention.

The invention relates to the field of health care reimbursement, and more particularly to valuing claims generated by a health care provider for purposes of underwriting and accelerating such health care provider's reimbursement from a variety of payors.

2. Description of the Related Art.

There was a time when people needed medical attention they paid the doctor directly for his or her professional services. Times have changed. Modem medicine can work miracles our grandparents never dreamed of, but sometimes at a staggering price. The provision of critical healthcare treatment is often regarded as a basic human right, regardless of whether the individual has the means to pay—at the same moment some forms of healthcare treatment cost more than a typical family's life savings. These days most Americans rely on a third party—either a private insurer, or a public governmental entity—to help them finance the cost of their medical needs.

Representing over 20 percent of the U.S. Gross Domestic Product, the health care industry is the single largest market in the U.S. today. Although the healthcare industry is a commercial market today, it didn't start out that way. In fact, the origins of these plans resided with providers (doctors and hospitals) and their desire to streamline the financial reimbursement process. In the beginning many managed care plans were formed by providers to provide predictable and reliable payment systems, or by companies to control employee medical costs. Over the course of the twentieth century healthcare plans evolved from being provider run, to adding employer run plans, to being financial institutions for all parties in the health care field much like insurance companies.

Toward the middle of the twentieth century health benefits began to be offered as an incentive to increase employment numbers. In the sixties, Medicare and Medicaid were formed by the Federal Government to help provide medical care to the elderly and poor, respectively. Toward the end of the twentieth century the majority of people were enrolled in some form of health insurance plan, with health maintenance organizations (HMO's) the most common. Today, the healthcare industry is a huge business, with many large managed care companies traded on the stock exchange. The healthcare industry accounts for approximately $1.5 trillion in market revenue.

Prescription drug spending is one of the fastest growing components of national health care spending, increasing at double-digit rates in each of the past 8 years. From 1993 to 2004, the number of prescriptions purchased increased 70% (from 2.0 billion to 3.7 billion), compared to a U.S. population growth of 13%. Additionally, U.S. spending for prescription drugs is projected to increase by 10.7 percent annually through 2013. As a subset of prescription drugs, High-Cost Therapeutics used by specialty Providers for in-office administration represent a growing portion of prescription drug sales.

The added complexities of the current health care system and the sheer volume of medicines being manufactured and administered has resulted in a long payment cycle. The health care provider cannot pay the manufacturer until the provider has received payment from the patient and/or the patient's insurance company or a government assistance program, which might also prove challenging. Today's health care organizations and individual providers face challenges processing and getting reimbursed for medical insurance claims. Shrinking reimbursement margins from governmental Payors under the Medicare Modernization Act of 2003 (“MMA”) and from certain commercial Payors influenced by the pricing paradigm created by the MMA has also put pressure on Providers that buy and bill for high-cost drugs administered in the Provider's office. Additionally, Manufacturers are subject to a variety of third-party influences on the selling price of their product that creates inefficiency and expense in the delivery of such High-Cost Therapeutics.

### SUMMARY OF THE INVENTION

The present invention is an automated business process platform that links pre-submission healthcare claims valuation and accounts receivable acquisition whereby comprehensive claims-level data is reported by a healthcare provider (“Provider”) to a third-party financial intermediary (“Financial Intermediary”) that incorporates such data into an appropriate format resulting in a pre-submission “draft claim.” The Financial Intermediary systematically presents the draft claim to the original Provider (or its agent) for verification and validation of the form and content of the claim, as well as the services. More specifically, once the Financial Intermediary receives the claim from its Provider customer, the Financial Intermediary applies specific pricing algorithms developed by the Financial Intermediary based on the Financial Intermediary's historical and updated database of Payor, Patient, and Provider information, as well as treatment, service, and therapeutic data, to arrive at an “allowable” amount for the subject claim and its various components.

This process also generates a contingent “purchase proposal” for presentation to the Provider based upon the draft claim. The purchase proposal identifies the claim(s) and components thereof together with the calculated allowable value for the draft claim(s). The Provider (or its agent) reviews and confirms the form and content of the claim, including verifying that the services and any drug administrations in the draft claim were actually provided and appropriate.

In this process, the Provider's confirmation of the draft claim automatically becomes the Provider's acceptance of the purchase proposal and authorization for the Financial Intermediary to submit the Provider-approved-and-verified claim for reimbursement. Concurrently, and subject to certain contractual conditions that ensure that the Provider maintains financial responsibility for any claims ultimately denied for lack of medical necessity or deemed experimental, the Financial Intermediary acquires by EFT (or other means) such approved claims that are not rejected by the subject clearing house and/or Payor at the price set forth in the purchase proposal.

This tool allows Providers to accelerate reimbursement from a number of payors by consolidating such payments into one Payor, which is the Financial Intermediary, consistent with regulatory management of reimbursement. The tool alleviates much of the overhead Providers currently spend on the business administration of their practice, including verification of benefits, claims valuation, appeals, collection, and steering qualified patients to qualified charitable organizations. The tool also helps Providers establish more consistent cash flow. Finally, this business process enables the Financial Intermediary to extract the drug portion of a health care claim from the traditional reimbursement cycle that links Manufacturers and Payors for direct drug purchases with a built in tracking mechanism to ensure that Payors are only paying for drugs actually and appropriately administered to the end Patient, again, all consistent with applicable regulatory objectives and mandates.

Currently, companies acquire medical receivables based on aging and gross billings and charge fees based on actual collections. Other companies provide component outsourcing for subsets of the services listed above. Unlike other tools in the market place, the present invention values the actual amounts due on the claims and automates accelerated payment to the Provider based on the allowable amount due without sacrificing Provider responsibility for appropriate administration of the underlying drugs and services.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic representation of the organizations in the health care system implementing the methods of the present invention.

FIG. 2 is a flowchart depicting the implementation of the methods of the present invention.

FIG. 3 is a flowchart diagram depicting the process used in drafting a purchase proposal.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

The detailed descriptions that follow are presented in part in terms of algorithms and symbolic representations of operations on data bits within a computer memory representing alphanumeric characters or other information. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory; rather they represent specific electronic structural elements that impart a physical organization on the information stored in memory. More than mere abstraction, the data structures are specific electrical or magnetic structural elements in memory that simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein that form part of the present invention; the operations are machine operations. Useful machines for performing the operations of the present invention include general-purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes or it may comprise a general-purpose computer as selectively activated or reconfigured by a computer program stored in the computer. The algorithms presented herein are not inherently related to any particular computer or other apparatus. In particular, various general-purpose machines may be used with programs written in accordance with the teachings herein, or it may prove more convenient to construct more specialized apparatus to perform the required method steps. The required structure for a variety of these machines will appear from the description below.

The present invention deals with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects. Objects may also be invoked recursively, allowing for multiple applications of an object's methods until a condition is satisfied. Such recursive techniques may be the most efficient way to programmatically achieve a desired result.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms that are used frequently have specialized meanings in the present context. The term “object” relates to a set of computer instructions and associated data that can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment.

The term “Browser” refers to a program which is not necessarily apparent to the user, but which is responsible for transmitting messages between the workstation and the network server and for displaying and interacting with the network user. Browsers are designed to utilize a communications protocol for transmission of text and graphic information over a worldwide network of computers, namely the “World Wide Web” or simply the “Web”. Examples of Browsers compatible with the present invention include the Navigator program sold by Netscape Corporation and the Internet Explorer sold by Microsoft Corporation (Navigator and Internet Explorer are trademarks of their respective owners). Although the following description details such operations in terms of a graphic user interface of a Browser, the present invention may be practiced with text based interfaces, or even with voice or visually activated interfaces, that have many of the functions of a graphic based Browser.

Browsers display information that is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a handheld device and a desktop computer either via wires or wirelessly. Synchronization ensures that the data on both the handheld device and the desktop computer are identical.

In wireless wide area networks, communication primarily occurs through the transmission of radio signals over analog, digital cellular, or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), personal digital cellular (“PDC”), or through packet-data technology over analog systems such as cellular digital packet data (CDPD”) used on the Advance Mobile Phone Service (“AMPS”). The terms “wireless application protocol” or “WAP” mean a universal specification to facilitate the delivery and presentation of web-based data on handheld and mobile devices with small user interfaces.

In relation to the Health Care field, this document uses some terms with specialized meanings. For example, “Financial Intermediary” is a reference to a generic financial processor which acts as as the facilitating entity—using a process of automated accounts receivable acquisition based upon the pre-submission claim-valuation and advance underwriting process. The terms “therapeutics” and “prescription” are meant to encompass all of pharmaceutical drugs, medical devices, and other materials used in the provision of health care to an individual. The term “order” refers to an amount of therapeutics or prescriptions that are to be delivered to a health care provider to administer a medical treatment to an individual. The term “provider” is refers to an individual physician or other health care organizations that are involved in the provision of health care to one or more individuals. The term “payor” refers to the individual or organization providing some or all direct payment or reimbursement for a health care transaction. The term “seller” refers to manufacturers, special pharmacies, distributors, and other resellers.

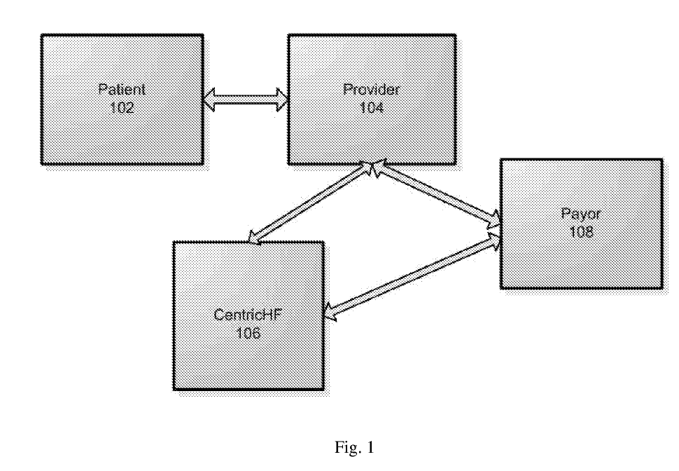

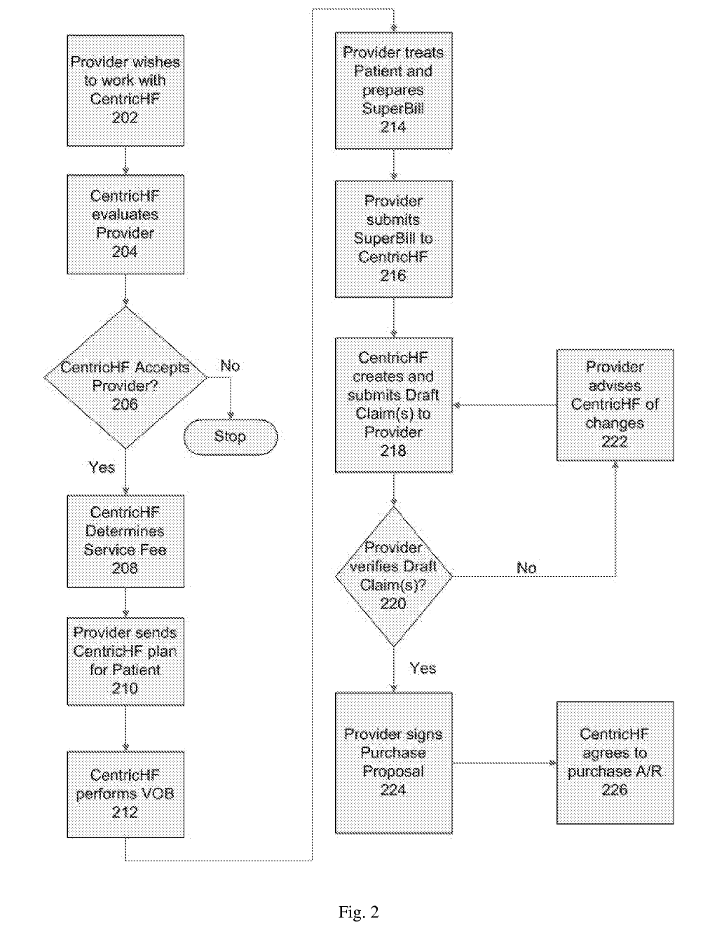

One embodiment of the present invention is depicted in FIGS. 1 and 2. The present invention begins with Provider 104 wishing to work within Financial Intermediary 106's single payor program (step 202). The single payor program provides an entire suite of services described above, including but not limited to claims valuation, verification of benefits, practice management consultation, appeals, collection, and streamlined referrals to qualified charitable organizations for the Provider's patients with demonstrated financial need. Financial Intermediary 106 enters into such an agreement after evaluating Provider 104 involved in terms of payor profile, claim volume, accounts receivable (A/R) history, and practice type (steps 204, 206). After evaluating the Provider's economic and practice profile, Financial Intermediary 106 determines a service fee to charge for the agreed-upon term (step 208).

Once Provider 104 is part of the program, such Provider 104 sends to Financial Intermediary 106, either electronically or by hard copy, a pre-treatment plan for Patient 102 (step 210). The information in the plan includes, but is not limited to, Patient 102 demographics, insurance coverage information, and the proposed treatment plan including applicable ICD9 (or International Classification of Diseases, Ninth Revision) codes. The ICD9 coding system is an international classification system which groups related disease entities and procedures for the purpose of reporting statistical information. The purpose of the ICD9 is to provide a uniform language and thereby serve as an effective means for reliable nationwide communication among physicians, patients, and third parties.

Financial Intermediary 106 then performs a verification of benefits (“VOB”) (step 212), including, but not limited to, one or more of the following: obtaining the patient's name, social security number, primary insurance provider, including Group ID number, plan type, copay amounts, effective date, termination date, prior authorization requirements, contact information at the carrier's office, and all similar information for secondary insurance. Financial Intermediary 106 sends the information required by or desired by Payor 108 to confirm the coverage of the patient for whom a claim may be prepared and submitted.

Provider 104 then treats Patient 102 and prepares a “Superbill” based on such treatment (step 214). The Superbill includes, but is not limited to, one or more of the following: patient identifier, date of treatment, diagnosis code(s), CPT code(s) for all service(s) performed during that visit, as well as any applicable notes. The Superbill may also be customized for a particular Payor 108.

Provider 104 then submits the Superbill to Financial Intermediary 106 either electronically or by hard copy (step 216). Financial Intermediary 106 then uses the information supplied by Provider 104 to draft a “claim” to be submitted after Provider 104 verification and approval to a designated clearing house for electronically formatted claims, or directly to Payor 108 for paper claims (step 218).

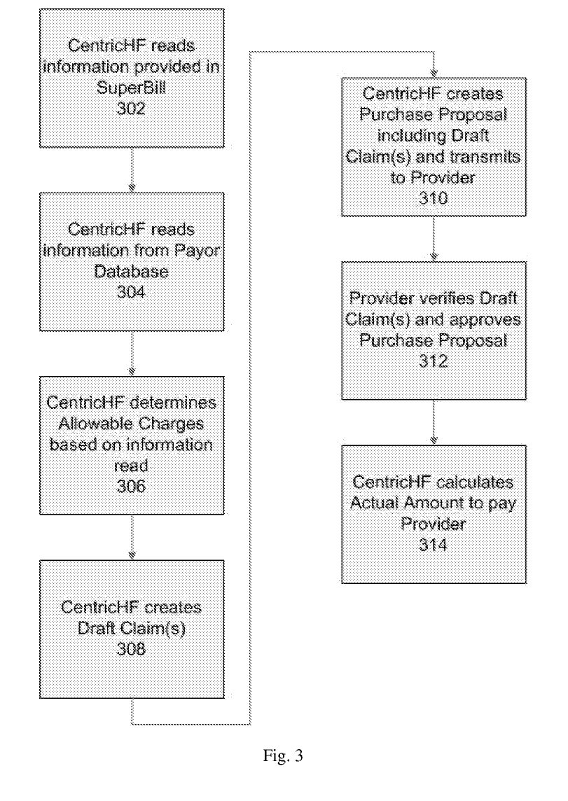

FIG. 3 depicts the process used in drafting a claim and purchase proposal. As part of Financial Intermediary 106's process in drafting a claim, Financial Intermediary 106 uses the information received from Provider 104 (step 302) to determine the actual charges for the administered services and/or drugs. In calculating the “allowable” value of claims, the Financial Intermediary applies specific pricing algorithms developed by the Financial Intermediary based on its own historical and updated database of Payor, Patient, and Provider information. Unlike conventional financial services that valuate and set a price once per contract period, the Financial Intermediary updates its database to include information that is as recent as possible to the current claim so that calculations based on the data base information may be calculated on a relatively current basis. The historical and updated database includes routinely updated Payor schedules for each specific CPT code and payment rates applicable to each specific Provider customer, which rates may be adjusted based on published changes and/or recent payment history in advance of such published changes. Through an automated process, the CPT codes on each superbill are compared to the information stored in the historical and updated database to calculate the allowable charge for every service line item. Thus, actual “allowable” charges for the particular line items of the claim(s) (step 306) are determined as provided in applicable Payor 108 contracts, Payor 108 payment schedules, pricing schedules and/or other information Financial Intermediary 106 utilizes on a current basis and maintains as part of its database for private and governmental payors (step 304).

Financial Intermediary 106 prepares a “purchase proposal” (step 310) for presentation to Provider 104. The purchase proposal identifies the claim(s) and components thereof together with the calculated allowable value for the draft claims. Similar to calculating the allowable value for the draft claims, Financial Intermediary 106 also uses the information received from Provider 104 and Financial Intermediary's database to calculate the amount Financial Intermediary 106 will pay to Provider 104 (step 314), net of the applicable service fees as determined above.

Provider 104 then reviews the draft claim (step 220) and either (a) verifies and approves the claim, including but not limited to, verifying the services rendered and/or drug(s) administered on the particular dates with the corresponding payment codes, or (b) advises Financial Intermediary 106 of any necessary changes to the draft claim (step 222) leading to a revised draft claim to be reviewed by Provider 104.

Provider 104 verifies and approves the claim by signing the purchase proposal either manually or electronically and transmitting the verification “signature” back to Financial Intermediary 106 (step 224).

If Financial Intermediary 106 receives a purchase proposal signed by Provider 104, Financial Intermediary 106 agrees to purchase the receivables and provide the other services net of the agreed service fee if the claim is not rejected by the clearinghouse used to funnel the claims to the applicable Payor 108 (or to Payor 108 directly if not part of the subject clearing house system) (step 226).

If the claim is not “rejected” at the initial submission stage by the clearing house or Payor 108, then Financial Intermediary 106 receives confirmation that the claim is being forwarded to Payor 108 for evaluation and Financial Intermediary 106 pays Provider 104 through EDP the net allowable amount of the claim(s) as set forth in the corresponding purchase proposal.

At that point, Financial Intermediary 106 owns the accounts receivable associated with the corresponding purchase proposal and works to collect on the claim(s). If the claim(s) is/are denied for lack of medical necessity or denied as “experimental,” Financial Intermediary 106 is entitled to collect that amount back from Provider 104.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

We claim:

1. A health care claims valuation and accounts receivable acquisition method, comprising the steps of:
a. obtaining claim-level data from health care provider;
b. retrieving historical and updated transaction data from a database;
c. calculating an allowable value amount for one or more claims based on the claim-level data and the historical and updated transaction data; and
d. calculating a purchase price based on the allowable value amounts.

2. The method of claim 1 wherein the historical transaction data includes historical and updated transaction data relating to Patient.

3. The method of claim 1 wherein the historical transaction data includes historical and updated transaction data relating to Payor.

4. The method of claim 1 wherein the historical transaction data includes historical and updated transaction data relating to Provider.

5. The method of claim 1, further comprising the steps of:
a. preparing a purchase proposal including allowable value amounts of one or more claims and the purchase price; and
b. transmitting the purchase proposal to Provider.

6. The method of claim 1, wherein the calculation of the purchase price includes subtracting service fees.

7. The method of claim 1, further comprising the steps of:
a. collecting the actual purchase amount from the provider.

8. A server computer for claims valuation and accounts receivable acquisition, said server comprising:
a. input software enabled to obtain claim-level data from health care provider on a current basis;
b. a database enabled to store a plurality of historical transaction data files inlcuding updated information on a current basis;
c. a first processing software enabled to calculate an allowable value amount for one or more claims based on the claim-level data and particular historical data files including current information relating to the claim;
d. a second processing software enabled to calculate the actual purchase price based on the allowable value amounts.

9. The server of claim 8 wherein the database includes historical and updated transaction data relating to Patient.

10. The server of claim 8 wherein the database includes historical and updated transaction data relating to Payor.

11. The server of claim 8 wherein the database includes historical and updated transaction data relating to Provider.

12. The server of claim 8, further comprising:
a. word processing software enabled to prepare a purchase proposal for Provider wherein purchase proposal includes allowable value amounts of one or more claims and the actual purchase price.

13. The server of claim 8, further comprising:
a. transmission software enabled to transmit purchase proposal to a Provider.

14. The server of claim 8, wherein the second processing software is capable of calculating the actual purchase price by subtracting service fees.
